(19) United States
(12) Patent Application Publication
(10) Pub. No.: US 2014/0075533 A1
(43) Pub. Date: Mar. 13, 2014

(54) ACCESSING RESOURCES THROUGH A FIREWALL

(71) Applicants: Jason V. Young, Denmark, WI (US); Shawn L. Riesterer, Green Bay, WI (US)

(72) Inventors: Jason V. Young, Denmark, WI (US); Shawn L. Riesterer, Green Bay, WI (US)

(73) Assignee: Orion Energy Systems, Inc.

(21) Appl. No.: 13/610,473

(22) Filed: Sep. 11, 2012

(51) Int. Cl. G06F 21/00

(52) U.S. Cl. 726/11

(57) ABSTRACT

Systems, methods, and computer-readable storage media for providing access to a firewalled resource are provided. A system includes a controller configured to be positioned outside of the firewall and configured to communicate with the client device and a mediator configured to communicate with the controller via a communications network. The mediator is configured to communicate with the resource and is configured to be positioned behind the firewall such that communications between the mediator and the resource do not traverse the firewall and communications between the mediator and the controller traverse the firewall. The mediator is configured to open a bidirectional connection between the mediator and the controller through which communications between the client device and protected resource may be transmitted. Requests forwarded by the mediator to the resource may be formatted in a manner such that they appear to the resource to be received from the client device.

### BACKGROUND

The present disclosure relates generally to the field of computing network security. Specifically, the present disclosure relates to systems, methods, and computer-readable storage media for allowing a user to access networked computing resources that are secured behind a firewall.

Connecting computing devices to communications networks the data and resources managed by the computing allows the devices to be accessed from a remote location. Network connectivity helps expand the functionality and usefulness of devices by allowing them to be accessed from anywhere as compared to only being able to access the computing devices locally. However, connecting computing devices to networks also opens the devices to additional security threats such as hackers, viruses, and malware. To prevent against such threats, networked computing devices are often protected by a hardware and/or software-based firewall. The firewall implements security policies that govern what outside devices can access the protected computing devices and what messages and data can be sent to and from the protected computing devices. While firewalls are an effective way of protecting networked computing devices from network-based attacks, firewalls can also make it difficult to connect the protected computing devices with legitimate outside client devices.

### SUMMARY

One embodiment of the disclosure relates to a system for providing access to a resource protected by a firewall by a client device. The firewall is configured to implement security policies to protect the resource from being accessed by unauthorized devices. The system includes a controller configured to be positioned outside of the firewall and configured to communicate with the client device. The system further includes a mediator configured to communicate with the controller via a communications network. The mediator is configured to communicate with the resource and is configured to be positioned behind the firewall such that communications between the mediator and the resource do not traverse the firewall and communications between the mediator and the controller traverse the firewall. The mediator is configured to open a bidirectional connection between the mediator and the controller. The controller is configured to receive a request from the client device and to transmit the request to the mediator through the bidirectional connection. The mediator is configured to forward the request to the resource. The forwarded request is formatted in a manner such that it appears to the resource to be received from the client device. The mediator is configured to receive a response from the resource and to transmit the response to the controller. The controller is configured to forward the response to the client device.

Another embodiment relates to a method for providing access to a resource protected by a firewall by a client device. The firewall is configured to implement security policies to protect the resource from being accessed by unauthorized devices. The method includes opening a bidirectional connection between a mediator and a controller. The controller is positioned outside of the firewall and configured to communicate with the client device. The mediator is configured to communicate with the controller via a communications network. The mediator is configured to communicate with the resource and is positioned behind the firewall such that communications between the mediator and the resource do not traverse the firewall and communications between the mediator and the controller traverse the firewall. The method further includes receiving, at the mediator through the bidirectional connection, a request from the controller. The request has been received at the controller from the client device. The method further includes forwarding the request from the mediator to the resource. The forwarded request is formatted in a manner such that it appears to the resource to be received from the client device. The method further includes receiving a response from the resource at the mediator and transmitting the response from the mediator to the controller. The controller is configured to forward the response to the client device.

Another embodiment relates to a computer-readable storage medium having instructions stored thereon that, when executed by at least one processor, cause the at least one processor to implement operations including opening a first bidirectional connection between a mediator and a cloud-based controller. The cloud-based controller is positioned outside of a firewall and configured to communicate with a client device. The firewall is configured to implement security policies to protect a resource from being accessed by unauthorized devices. The mediator is configured to communicate with the cloud-based controller via a communications network. The mediator is configured to communicate with the resource and is configured to be positioned behind the firewall such that communications between the mediator and the resource do not traverse the firewall and communications between the mediator and the cloud-based controller traverse the firewall. The operations further include receiving, at the mediator through the first bidirectional connection, a request from the cloud-based controller. The request was received at the cloud-based controller from the client device. The operations further include forwarding the request from the mediator to the resource. The forwarded request is formatted in a manner such that it appears to the resource to be received from the client device. The operations further include receiving a response from the resource at the mediator and opening a second connection between the mediator and the cloud-based controller. The operations further include transmitting the response from the mediator to the cloud-based controller through the second connection. The cloud-based controller is configured to forward the response to the client device.

### BRIEF DESCRIPTION OF THE DRAWINGS

FIG. 1 is a block diagram of an existing system for accessing a firewalled resource. Conventional systems for accessing a firewalled resource include a port that is left open. This typically requires manual IT setup and support and leaves the port open even when the systems are not active.

FIG. 2 is a block diagram of a system for accessing a firewalled resource according to an exemplary embodiment;

FIG. 3A is a block diagram of a system for accessing a firewalled resource using a mediator device according to an exemplary embodiment.

FIG. 3B is a flow diagram of a process for accessing a firewalled resource using the system illustrated in FIG. 3A according to an exemplary embodiment.

FIG. 4A is a block diagram illustrating the transmission of a block of data between the client device and the firewalled resource in the system of FIG. 3A according to an exemplary embodiment.

FIG. 4B is a flow diagram of a process for transmitting a block of data between the client device and the firewalled resource using the system illustrated in FIG. 4A according to an exemplary embodiment.

FIG. 5A is a block diagram of a system for accessing a firewalled resource that allows transmission of a stream of data between a client device and a firewalled resource according to an exemplary embodiment.

FIG. 5B is a flow diagram of a process for transmitting a stream of data between the client device and the firewalled resource using the system illustrated in FIG. 5A according to an exemplary embodiment.

FIG. 6A is a block diagram of a system for accessing a firewalled resource according to another exemplary embodiment.

FIG. 6B is a flow diagram of a process for accessing a firewalled resource using the system illustrated in FIG. 6A according to an exemplary embodiment.

FIG. 7 is a block diagram of a computing device according to an exemplary embodiment.

### DETAILED DESCRIPTION

Before turning to the figures, which illustrate the exemplary embodiments in detail, it should be understood that the application is not limited to the details or methodology set forth in the description or illustrated in the figures. It should also be understood that the terminology is for the purpose of description only and should not be regarded as limiting.

Referring generally to the figures, systems, methods, and computer-readable storage media for providing access to resources protected by a firewall are provided according to various exemplary embodiments. The embodiments utilize a controller outside of the firewall (e.g., such that inbound communications to the controller are not protected by the firewall and are not subject to the security policies of the firewall) that communicates with a firewalled device. In various embodiments, the controller may be a cloud-based controller (e.g., such that the functions of the controller are implemented using a plurality of computing devices in a cloud service, such as the Amazon Elastic Compute Cloud, or Amazon EC2) or one or more network-accessible remote server devices. The controller is configured to communicate between the firewalled resource and one or more client devices. In some embodiments, the firewalled resource may be a lighting management system configured to control the operation of one or more lighting devices.

In some embodiments, the controller may be configured to transmit configuration information or instructions to a client device to allow the client device to communicate directly with a resource through the firewall. The controller may receive connection information from the firewalled resource including information needed to connect with the resource through the firewall. The controller may generate instructions for the client device based on the connection information that indicate to the client device how to connect directly to the firewalled resource through the firewall. The instructions may then be sent to the client, and the client may use the instructions to open a direct connection to the firewalled resource.

In some embodiments, the controller may be configured to communicate with a mediator device positioned behind the firewall (e.g., on a same side of the firewall as the firewalled resource) to relay transmissions between the firewalled resource and one or more client devices. The mediator may be configured to open a bidirectional connection or communication link between the mediator and the controller through the firewall. The mediator may be permitted to open the connection because it is a trusted device positioned behind the firewall, and once the connection is opened the firewall may be configured to permit both inbound and outbound communications via the connection. The controller may receive a request from a client device and send the request to the mediator using the previously established bidirectional link. The mediator may then be configured to forward the request to the resource. The request may be formatted in a manner such that it appears to the resource to be received directly from the client device. The resource may send a response back to the mediator, which may send the response through the firewall to the controller. The controller may then forward the response to the client device. In this manner, the client device may communicate with the firewalled resource through the firewall without opening a direct connection between the resource and the client device.

In some embodiments, a system for providing access to a firewalled resource may utilize a combination of the features noted above. For example, a controller may be configured to communicate with a mediator device positioned behind the firewall as described above. The controller may receive connection information including information used in communicating with the resource through the firewall. The controller may determine whether the client device is able to connect directly with the firewalled resource based on the connection information. If the connection information indicates that the client device can communicate directly with the firewalled resource, the controller may transmit instructions to the client device that the client device may use to form a direct connection with the firewalled resource. If the connection information indicates that the client device cannot communicate directly with the resource through the firewall, the controller and mediator device may be configured to serve as intermediary devices for communications between the client device and the firewalled resource in the manner described above.

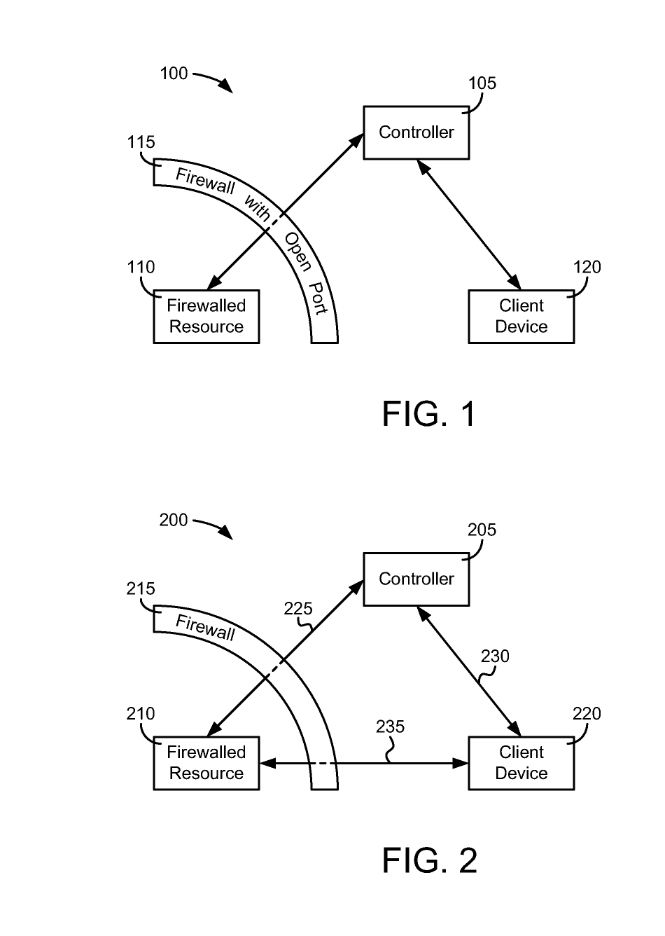

FIG. 1 is a block diagram of an conventional and existing system for accessing a firewalled resource. Conventional systems for accessing a firewalled resource include a port that is left open. This typically requires manual IT setup and support and leaves the port open even when the systems are not active. System 100 includes a controller 105 configured to communicate bidirectionally with a firewalled resource 110 through a firewall 115. System 100 is configured to route all communications between client device 120 and firewalled resource 110 through controller 105. No communications are permitted directly between client device 120 and resource 110. The IT infrastructure serving firewalled resource 110 must be manually configured (e.g., by an IT manager opening a port) to allow outgoing and incoming communications between firewalled resource 110 and controller 105. The setup of the system of FIG. 1 may require a high level of coordination from the IT infrastructure, only to result in a disadvantageous permanently open port.

Referring now to FIG. 2, a block diagram of a system 200 of the present invention is shown, according to an exemplary embodiment. System 200 is configured to provide for direct communication between a client device 220 and firewalled resource 210. System 200 includes a controller 205 (e.g., a cloud-based controller or one or more server devices) configured to receive at least outbound communications from resource 210 through a firewall 215 via a connection 225. The communications received by controller 205 from resource 210 may include connection information. For example, the connection information may include one or more port numbers through which a device (e.g., device 220) outside of firewall 215 can connect with resource 210, security codes or information needed to gain authorization of firewall 215 to send inbound signals to resource 210, addressing information (e.g., IP addresses) of resource 210 and/or any parent or intervening devices (e.g., a gateway), and/or other types of information. In some embodiments, multiple levels of parent devices may be involved in the connection between resource 210 and controller 205. In some embodiments, the connection information may be sent to controller 205 as part of a heartbeat signal. The heartbeat signal may include status information or other data that is communicated from resource 210 to controller 205 and allows controller 205 to monitor resource 210. The heartbeat signal may be transmitted at periodic intervals, upon the occurrence of one or more events, at random or pseudo-random times, or in some other manner.

Controller 205 may be configured to generate instructions that may be used by client device 220 to connect directly with resource 210 through firewall 215. The instructions may be transmitted to client device 220 in response to receiving a request to access resource 210 from client device 220. In some embodiments, controller 205 may be configured to forward the connection information to client device 220 in the form in which it was received from resource 210. In some embodiments, controller 205 may be configured to generate configuration instructions or configuration data from the connection information that may be used and/or executed by client device 220 to configure client device 220 for direct communication with resource 210 in a manner that is permitted by firewall 215. The generated configuration instructions may be sent to client device 220, and client device 220 may use the instructions to open a connection 235 (e.g., a bidirectional connection) with resource 210 through firewall 215. In some embodiments, only outbound communications from resource 210 to controller 205 may be permitted and not inbound connections from controller 205 to resource 210. This may help avoid a need for a static and highly IT managed port to be open at the firewalled resource 210 location for receiving inbound communications from controller 205.

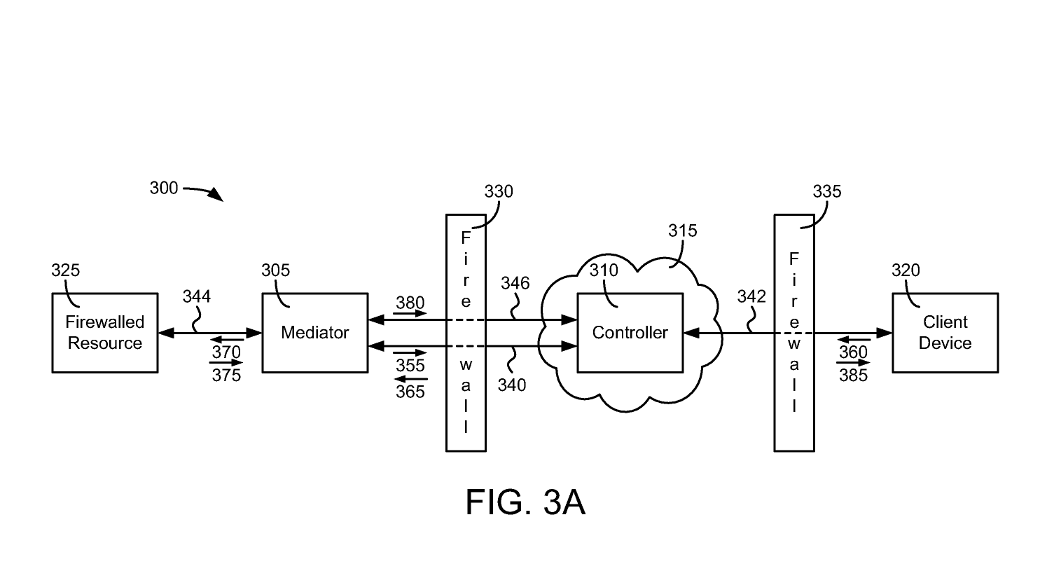

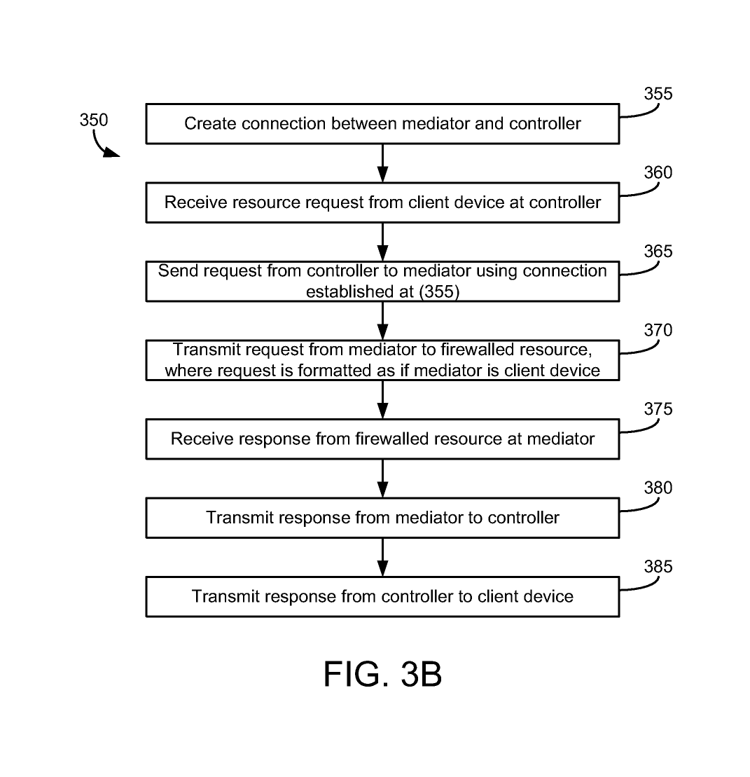

Referring now to FIGS. 3A and 3B, a system 300 and process 350 are shown that use a mediator device to provide communications between client devices and a firewalled resource according to exemplary embodiments. Referring specifically to FIG. 3A, system 300 includes a mediator 305 that is positioned behind a firewall 330 used to protect a firewalled resource 325 (e.g., a local networked light management system of a building or group of buildings). Mediator 305 is configured to communicate through firewall 330 with a controller 310 (e.g., a cloud-based controller or one or more server devices) that is accessible through a communications network 315. Because mediator 305 is on a protected or trusted side of firewall 330, connections between mediator 305 and controller 310 that are initiated by mediator 305 may be trusted and allowed by firewall 330. Controller 310 may be configured to communicate with one or more client devices, such as a client device 320. In some embodiments, client device 320 may be protected by another firewall 335. System 300 is configured such that all communications between client device 320 and firewalled resource 325 are routed through controller 310 and mediator 305. System 300 may allow communication between client devices and resource 325 without requiring either the client devices or controller 310 to be specially configured to allow inbound communications to pass through firewall 330. Communications between client devices and resource 325 may be configured such that the communications appear to be directly between the client devices and resource 325 and little or no special configuration of the client devices and/or resource 325 is needed to account for the communications being routed through mediator 305 and controller 310.

FIG. 3B illustrates a process 350 for transmitting requests and responses between client device 320 and resource 325 according to an exemplary embodiment. FIG. 3A illustrates arrows marked with the reference numbers of the operations of process 350 to illustrate data flow through system 300 associated with process 350. Mediator 305 is configured to create a bidirectional connection 340 with controller 310 through firewall 330 (355). In some embodiments, mediator 305 may be configured to open connection 340 once mediator 305 comes online. Mediator 305 may be configured to transmit connection information to controller 310 via connection 340 such as an identifier (e.g., identification number) for the mediator and/or security information used to communicate across firewall 330. In some embodiments, connections between mediator 305 and controller 310, as well as connections between other devices, may be made using the hypertext transfer protocol (HTTP). In some embodiments, the connection between mediator 305 and controller 310 may be made using port 80.

Controller 310 waits to receive a request from client device 320 relating to resource 325 (360). The request may include a request to adjust one or more settings of resource 325 or a request to receive data from resource 325. For example, in an embodiment in which resource 325 is a lighting management system, client device 320 may request that the lighting management system activate or deactivate one or more lighting devices, change settings (e.g., activation/deactivation time settings) associated with controlling the lighting devices, or transmit data to client device 320 relating to the control or use of the lighting devices (e.g., energy usage data or activation/deactivation time data). The request may include details relating to what is requested as well as a port identifier (e.g., identifying a port at which resource 325 is located) and a destination identifier (e.g., identifying specific data, resource file, script, html page, directory location, or settings of resource 325 associated with the request). Once the request is received via a connection 342 between client device 320 and controller 310, controller 310 may be configured to send the request details to mediator 305 via the previously established bidirectional connection 340 (365). Inbound communications through connection 340 may be permitted by firewall 330 because the connection was initiated by mediator 305, which is installed on a trusted side of firewall 330, and connection 340 has already traversed firewall 330. Controller 310 may be configured to add a unique request identifier to the request so that a response to the request can be later identified and transmitted to the correct client device.

Mediator 305 is configured to receive the request from controller 310 and make a new request to firewalled resource 325 over a connection 344 (370). The request may be formatted in a manner such that it appears to resource 325 to be received directly from client device. For example, the request may include various details about client device 320 that would be included with the request if received directly from client device 320, such as an operating system used by client device 320, a type and build number of the web browsing software used by client device 320 to send the request, tracking cookies associates with client device 320, and/or other types of data. In some embodiments, mediator 305 may be configured to remove the request identifier from the request prior to forwarding the request to resource 325. Firewalled resource 325 may be configured to receive the request and generate an appropriate response to the request. In some embodiments, the response may include a confirmation that an action was performed or a setting was changed. In some embodiments, the response may include data requested by client device 320.

The response from resource 325 may be received at mediator 305 (375). Mediator 305 may be configured to add the request identifier to the response and send the response to controller 310 (380). In some embodiments, the response may be transmitted from mediator 305 to controller 310 using a new connection 346 (e.g., a unidirectional or bidirectional connection) opened by mediator 305. Using new connection 346 may help reduce lag time for requests on the original connection 340 due to waiting for the response to be transmitted. In some embodiments, connection 346 may be closed after the response is transmitted. In some embodiments, connection 346 may be held open and used for other communications for efficiency. Controller 310 may be configured to determine the destination client device 320 based on the request identifier and transmit the response to client device 320 (385). In some embodiments, the response may be formatted in a manner such that it appears to client device 320 to have been received directly from resource 325. For example, information from resource 325 may be included with the response and/or the request identifier may be removed by controller 310. The response may be transmitted to client device 320 over connection 342 or a different connection. Connection 342 may be closed after the response has been transmitted.

Some network-connected appliances and firewalls are configured to terminate idle connections that traverse the firewall after a certain period of time to reduce the risk that the connections will be used as part of a network-based attack on protected resources. For example, some appliances may be configured to terminate a connection if it has been idle (e.g., if no data signals have been received on the connection) for a period of time such as five minutes or one minute. If bidirectional connection 340 between mediator 305 and controller 310 is terminated, controller 310 may hold requests until the connection is reestablished by mediator 305, increasing lag time before requests are transmitted and responses are received. In some instances, requests may be delayed by a time delay of 100 milliseconds or greater due to connection termination.

In some embodiments, mediator 305 may be configured to open new bidirectional connections between mediator 305 and controller 310 to avoid having the only bidirectional connection between mediator 305 and controller 310 be terminated. For example, if an appliance is configured to terminate connections at five minutes of idle time, a new secondary bidirectional connection to controller 310 may be opened by mediator 305 sometime before five minutes after connection 430 was opened (e.g., at four minutes, 4.5 minutes, etc.). In some embodiments, mediator 305 may be configured to monitor historical connection data to determine when an appliance is terminating idle connections to determine an appropriate timeframe for opening new connections. In some embodiments, mediator 305 may be configured to open new connections frequently (e.g., every 30 seconds) to avoid the likelihood of connections being terminated rather than or in addition to monitoring connection data to determine the termination timeframe of the appliance.

In some embodiments, mediator 305 may be configured to keep software controlling operation of mediator 305 in synchronization with software controlling controller 310. For example, mediator 305 may send a request to controller 310 for a current version number of the software for controller 310 and/or mediator 305. Controller 310 may reply with information that may be used by mediator 305 to determine if the software version currently being used by mediator 305 is the software version intended to be used in conjunction with the current software of controller 310. If the software of mediator 305 is not the version that matches the current software of controller 310, mediator 305 may download the appropriate software version (e.g., through controller 310 or through a connection to a different server or cloud service) and update itself. This may help ensure maximum compatibility between mediator 305 and controller 310 and avoid the need for the software of controller 310 to be backwards-compatible.

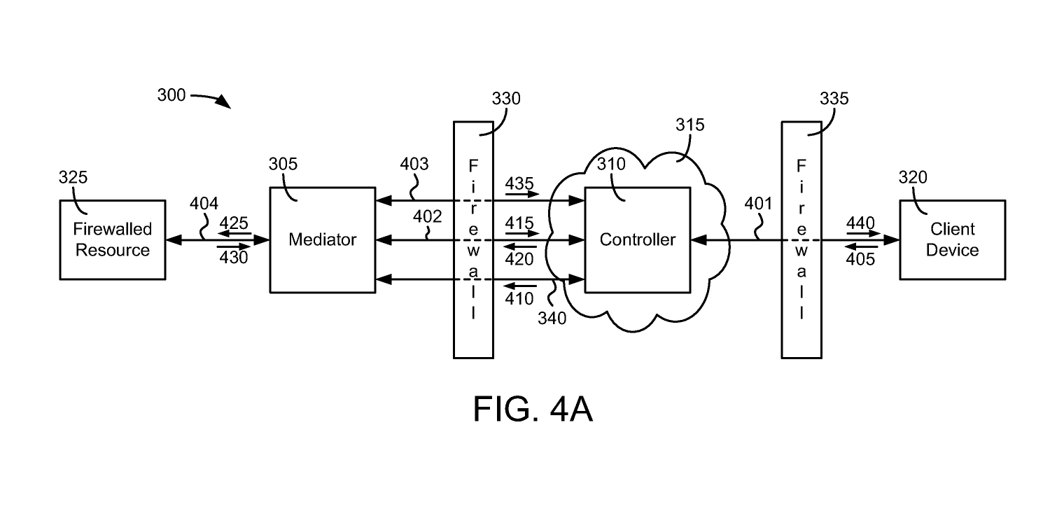

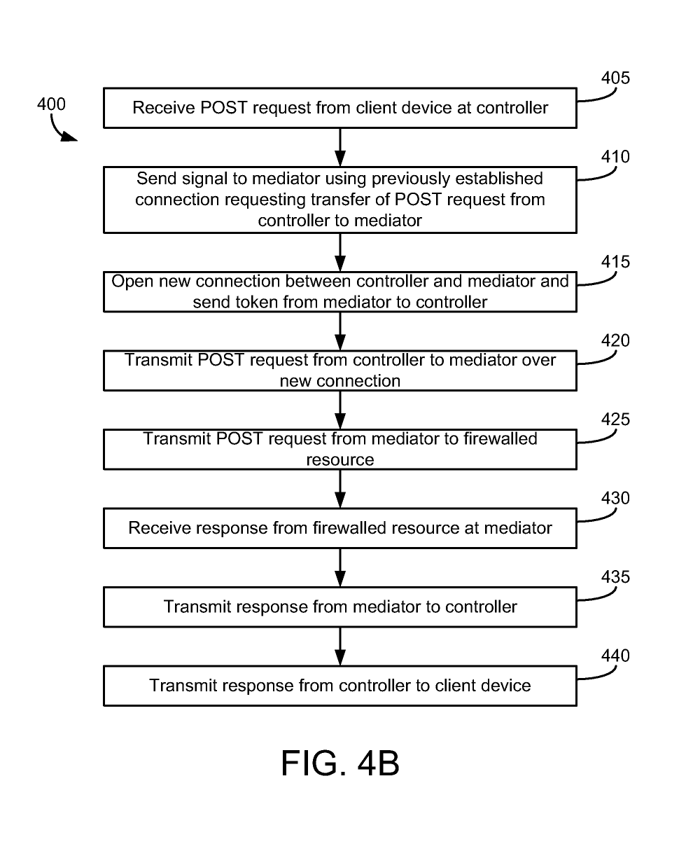

Referring now to FIGS. 4A and 4B, a block diagram and flow diagram illustrating a process 400 for transmission of a block of data between client device 320 and resource 325 in system 300 are shown according to an exemplary embodiment. FIG. 4A illustrates arrows marked with the reference numbers of the operations of process 400 to illustrate data flow through system 300 associated with process 400. In some embodiments, process 400 may be used to transfer a block of data from client device 320 to resource 325 and/or to transfer a block of data in response from resource 325 to client device 320. As with process 350, data transmitted to client device 320 and resource 325 may be formatted in a manner such that it appears to be coming directly from the other of client device 320 and resource 325.

A request to transfer a block of data, including the data itself, is received at controller 310 from client device 320 via a connection 401 (405). In some embodiments, the request may be a HTTP POST request. Controller 310 may transmit a signal to mediator 305 via connection 340 indicating that a request to transfer a block of data has been received and that controller 310 is seeking permission to transfer the request and data to mediator 305 (410). Mediator 305 may open a new connection 402 to controller 310 and transmit a token to controller 310 that controller 310 may use to transfer the request and data (415). Controller 310 may then transfer the request and data to mediator 305 via connection 402 (420). Mediator 305 may subsequently forward the request and data to resource 325 via a connection 404 (425). Resource 325 may store the data or use the data to perform a function.

Mediator 305 may receive a response from resource 325 (430). In some embodiments, the response may be a confirmation that the request and data block were successfully received. In some embodiments, the response may be a block of data to be sent from resource 325 to client device 320 in response to the block of data received from client device 320. Mediator 305 may transmit the response to controller 310 (435), which may in turn forward the response to client device 320 (440). In some embodiments, mediator 305 may open a new outbound connection 403 to transmit the response to controller 310. In some embodiments, all data transferred between devices in process 400 may be sent as a stream and not buffered.

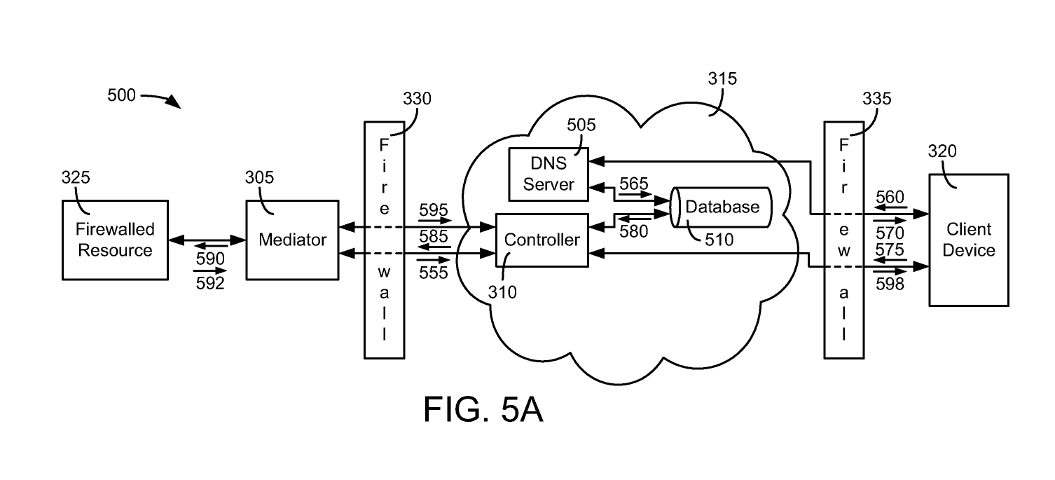

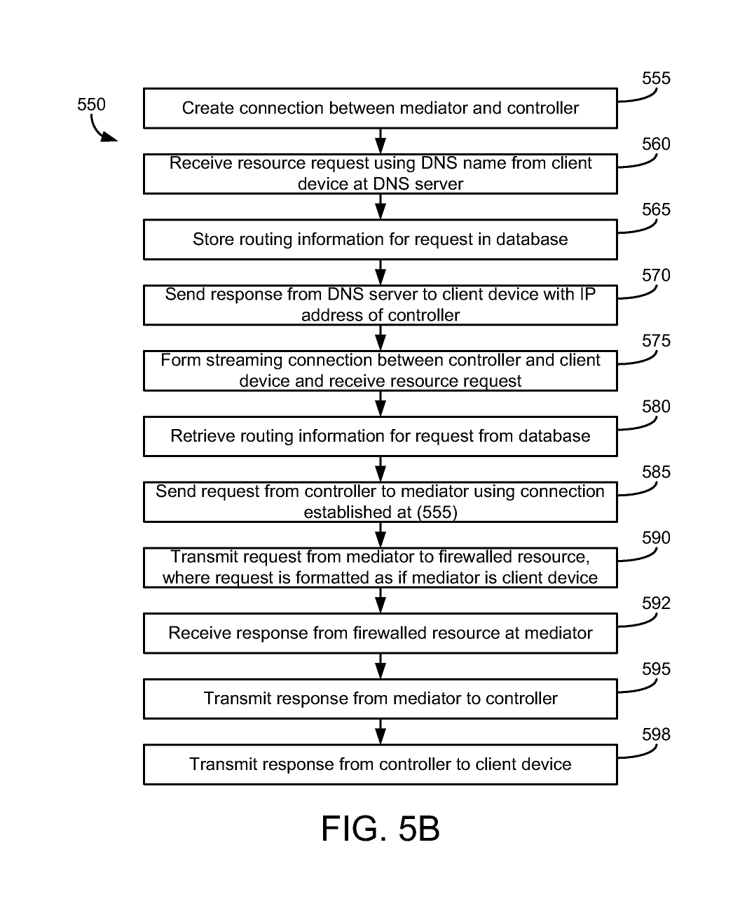

Referring now to FIGS. 5A and 5B, a block diagram and flow diagram illustrating a system 500 and process 550 for transmission of a stream of data between client device 320 and resource 325 is shown according to an exemplary embodiment. FIG. 5A illustrates arrows marked with the reference numbers of the operations of process 550 to illustrate data flow through system 500 associated with process 550. In some embodiments, process 550 may be used to transfer streaming data from client device 320 to resource 325 and/or to transfer streaming data in response from resource 325 to client device 320. As with processes 350 and 400, data streamed to client device 320 and resource 325 may be formatted in a manner such that it appears to be coming directly from the other of client device 320 and resource 325. In some embodiments, system 500 and/or process 550 may be implemented using the IPV6 protocol, which allows for access to a very large number of IP addresses.

A bidirectional connection between mediator 305 and controller 310 may be opened, for example when mediator 305 comes online (555). A resource request may be received at a DNS server 505 from client device 320 and may include a DNS name, a destination identifier, and a port identifier (560). DNS server 505 may store routing information relating to the request in a database 510 (565) and may transmit a response to client device 320 including a unique IP address belonging to controller 310 (570). A streaming connection may then be formed between controller 310 and client device 320, and controller 310 may receive the resource request from client device 320 (575). Controller device may retrieve routing information for the request from database 510 (580). The request may then be forwarded to firewalled resource 325 and a response may be routed from resource 325 to client device 320 according to operations 585, 590, 592, 595, and 598, which are substantially similar to operations 365, 370, 375, 380, and 385 of process 350, respectively. System 500 and process 550 may enable streaming of data between client device 320 and resource 325 without using hypertext transfer protocol (HTTP) requests.

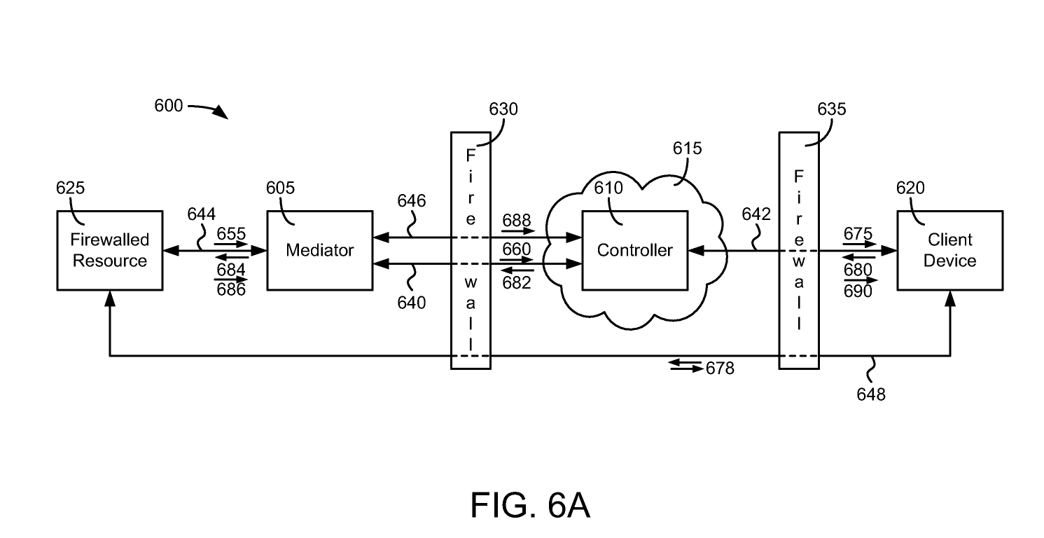

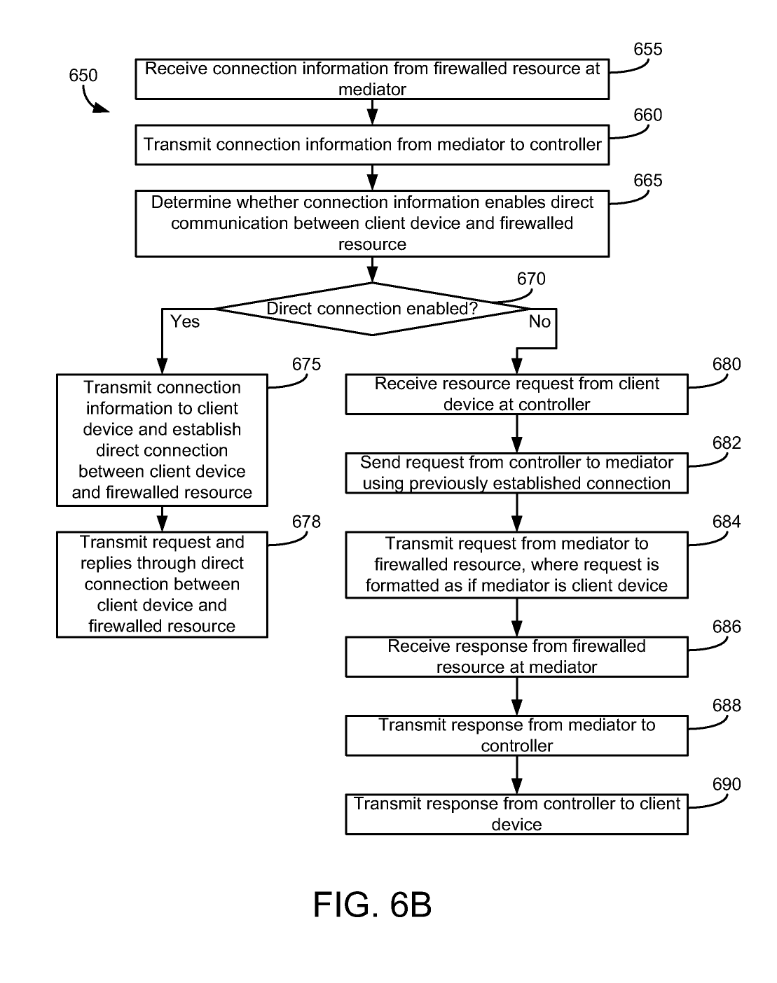

Referring now to FIGS. 6A and 6B, a block diagram and flow diagram of another system 600 and method 650 for allowing communication between a client device and a firewalled resource is shown according to an exemplary embodiment. System 600 and method 650 are configured to utilize a connection hierarchy in which a controller 610 first attempts to establish a direct connection between a client device 620 and a firewalled resource 625 and, if such a direct connection is not permitted by a firewall 630 protecting resource 625, then communications are routed through controller 610 and a mediator 605. System 600 includes components that are similar to those included in system 300 and function in a similar manner except as noted with respect to process 650. FIG. 6A illustrates arrows marked with the reference numbers of the operations of process 650 to illustrate data flow through system 600 associated with process 650. As with processes 350, 400, and 500, data and requests transmitted to client device 620 and resource 625 may be formatted in a manner such that they appear to be coming directly from the other of client device 620 and resource 625.

Referring now to FIG. 6B, mediator 605 may receive connection information from resource 625 (655). Mediator 605 may establish a bidirectional connection 640 through firewall 630 with controller 610 and may transmit connection information to controller 610 (660). Controller 610 may determine based on the connection information whether a direct connection between client device 620 and firewalled resource 625 is permissible under the security policies of firewall 630 (665). If controller 610 determines that firewall 630 will permit a direct connection (670), controller 610 may transmit configuration instructions to client device 620 and client device 620 may use the configuration instructions to establish a direct connection with resource 625 through firewall 630 (675). In some embodiments, the instructions transmitted to client device 620 may include a redirect instruction providing information allowing for a direct connection between client device 620 and resource 625. In some embodiments, the instructions may include a list of options for connecting with resource 625. For example, client device 620 may be connected as part of the same network as resource 625 and connected on a trusted side of firewall 630. In such an instance, the options provided to client device 620 may include connecting directly with resource 625 behind firewall 630 or transmitting requests through controller 610. Client device 620 would likely select connecting directly with resource 625 rather than sending the request out of firewall 630 to controller 610 for routing back through firewall 630 to resource 625. Request and data transmissions may be performed directly between client device 620 and resource 625 (678). By using a direct connection, the transmissions between client device 620 and resource 625 may not be subject to delays associated with routing the transmissions through controller 610 and mediator 605.

If controller 610 determines that firewall 630 will not permit a direct connection between client device 620 and resource 625 (670), request and data transmissions may be routed through controller 610 and mediator 605. Operations 680, 682, 684, 686, 688, and 690 may be used to route requests from client device 620 to resource 625 and responses from resource 625 to client device 620 and are similar to operations 360, 365, 370, 375, 380, and 385 of process 350, respectively.

In some embodiments, client device 620 may include software configured to perform part or all of the operations described above as being performed by controller 610. For example, client device 620 may receive the connection information and determine whether a direct connection can be formed with resource 625. In some embodiments, a combination of controller 610 and client device 620 may perform the operations.

In various embodiments, traffic between a mediator and controller may be routed in different ways. For example, in some embodiments, all traffic between the mediator and the controller may be routed over the initial bidirectional connection between the mediator and controller that is held open for the mediator to receiver requests from the controller. In some embodiments, the mediator may receive all requests from the controller over the initial bidirectional connection but may open a new connection with the controller for each response to be transmitted to the controller. In some embodiments, connections opened for responses may be closed shortly after the responses are transmitted to the controller. In some embodiments, secondary connections between the mediator and controller opened to send responses may be held opened and reused to transmit other traffic between the mediator and controller rather than opening new connections. Using multiple connections for different traffic may allow for the simultaneous transmission of data between the mediator and controller while reducing or eliminating the need to use transmission management methods on the initial bidirectional connection to queue the data and manage what data is sent at what time across the connection.

Embodiments above are described with respect to sending packets of data between client devices, controllers, mediators, and firewalled resources. In some embodiments, data may be streamed between devices rather than or in addition to being sent in packetized form. In some embodiments, connections may be maintained between devices, and requests (e.g., POST requests) may be sent as a stream of data. In some embodiments, a portion of received data may be forwarded to another device before the entire data has been received. For example, a controller may be receiving a streaming POST request from a client device and may transmit a first portion of the POST request to a mediator device before receiving the last portion of the POST request from the client device.

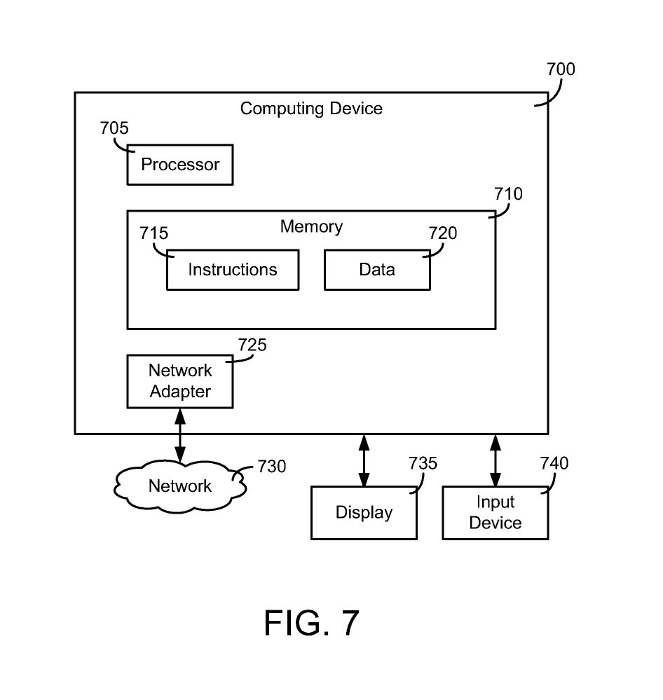

Referring now to FIG. 7, a block diagram of a computing device 700 is shown according to an exemplary embodiment. Device 700 may be utilized as part of any or all of the components of systems 100, 200, 300, and/or 600, such as a mediator device, controller, client device, and protected resource. Device 700 includes a processor 705 configured to execute instructions to perform various functions of device 700. Processor 705 may be any type of general purpose or special purpose processing circuit (e.g., ASIC, CPLD, FPGA, etc.). Device 700 also includes a memory 710 configured to store instructions 715 that may be executed by processor 705 to perform the functions of device 700 and other data 720. Memory 710 may be any type of computer or machine-readable storage medium (e.g., RAM, ROM, EEPROM, flash, optical, etc.).

Device 700 may also include interfaces used to connect with devices external to device 700. Device 700 may include a network adapter 725 configured to transmit data to and receive data from a communications network 730. Network 730 and network adapter 725 may be configured to achieve any type of networking configuration, such as wired (e.g., via Ethernet), wireless (e.g., via WiFi, Bluetooth, etc.), pre-configured, ad-hoc, LAN, WAN (e.g., Internet), etc. In some embodiments, device 700 may include input/output interfaces configured to transmit display data to a display device 735 and/or to receive input data from a user via an input device 740.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials and components, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure may contemplate methods, systems and program products on any machine-readable storage media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable storage media for carrying or having machine-executable instructions or data structures stored thereon. Such machine-readable storage media can be any available media that can be accessed by a general purpose or special purpose computer or other machine with a processor. By way of example, such machine-readable storage media can comprise RAM, ROM, EPROM, EEPROM, CD-ROM or other optical disk storage, magnetic disk storage or other magnetic storage devices, flash memory, or any other medium which can be used to carry or store desired program code in the form of machine-executable instructions or data structures and which can be accessed by a general purpose or special purpose computer or other machine with a processor. Machine-readable storage media are tangible storage media and are non-transitory (i.e., are not merely signals in space). Combinations of the above are also included within the scope of machine-readable storage media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps, and decision steps.

What is claimed is:

1. A system for providing access to a resource protected by a firewall by a client device, the firewall being configured to implement security policies to protect the resource from being accessed by unauthorized devices, the system comprising:
a controller configured to be positioned outside of the firewall and configured to communicate with the client device; and
a mediator configured to communicate with the controller via a communications network, wherein the mediator is configured to communicate with the resource and is configured to be positioned behind the firewall such that communications between the mediator and the resource do not traverse the firewall and communications between the mediator and the controller traverse the firewall,
wherein the mediator is configured to open a bidirectional connection between the mediator and the controller,
wherein the controller is configured to receive a request from the client device and to transmit the request to the mediator through the bidirectional connection,
wherein the mediator is configured to forward the request to the resource, the forwarded request being formatted in a manner such that it appears to the resource to be received from the client device,
wherein the mediator is configured to receive a response from the resource and to transmit the response to the controller, and
wherein the controller is configured to forward the response to the client device.

2. The system of claim 1, wherein the mediator is configured to open a second connection between the mediator and the controller and use the second connection when transmitting the response to the controller.

3. The system of claim 1, wherein the controller is a cloud-based controller accessible to the mediator and the client device over the communications network, and wherein communications between the cloud-based controller and the mediator and client device are formatted as hypertext transfer protocol (HTTP) communications.

4. The system of claim 1, wherein the mediator is configured to:
receive a request from the controller to transfer a block of data from the client device to the resource;
open a second connection between the mediator and the controller;
receive the block of data from the controller, the block of data having previously been received at the controller from the client device; and
transmit the block of data to the resource.

5. The system of claim 4, wherein the request to transfer a block of data is a hypertext transfer protocol (HTTP) POST request.

6. The system of claim 4, wherein the mediator is further configured to receive a response to receiving the block of data from the resource and to transmit the response to receiving the block of data to the controller.

7. The system of claim 6, wherein the mediator is configured to open a third connection between the mediator and the controller and to transmit the response to receiving the block of data to the controller over the third connection.

8. The system of claim 1, wherein the mediator is configured to:
open a streaming data connection between the mediator and the controller;
receive streaming data from the controller, the streaming data having been received by the controller from the client device; and
transmit the streaming data to the resource.

9. The system of claim 8, wherein the streaming data connection is a secure shell (SSH) connection.

10. The system of claim 1, wherein the mediator is configured to:
determine that the firewall is configured to close connections between the mediator and the controller after a maximum idle time; and
open new connections between the mediator and the controller at a periodic interval that is less than the maximum idle time.

11. The system of claim 10, wherein the resource comprises a lighting control system configured to control one or more lighting devices.

12. A method for providing access to a resource protected by a firewall by a client device, the firewall being configured to implement security policies to protect the resource from being accessed by unauthorized devices, the method comprising:
opening a bidirectional connection between a mediator and a controller, wherein the controller is positioned outside of the firewall and configured to communicate with the client device, wherein the mediator is configured to communicate with the controller via a communications network, and wherein the mediator is configured to communicate with the resource and is positioned behind the firewall such that communications between the mediator and the resource do not traverse the firewall and communications between the mediator and the controller traverse the firewall;
receiving, at the mediator through the bidirectional connection, a request from the controller, the request having been received at the controller from the client device;
forwarding the request from the mediator to the resource, the forwarded request being formatted in a manner such that it appears to the resource to be received from the client device; and
receiving a response from the resource at the mediator and transmitting the response from the mediator to the controller, wherein the controller is configured to forward the response to the client device.

13. The method of claim 12, further comprising opening a second connection between the mediator and the controller and using the second connection when transmitting the response from the mediator to the controller.

14. The method of claim 12, wherein the controller is a cloud-based controller accessible to the mediator and the client device over the communications network, and wherein the method further comprises formatting communications from the mediator to the cloud-based controller as hypertext transfer protocol (HTTP) communications.

15. The method of claim 12, further comprising:
receiving, at the mediator, a request from the controller to transfer a block of data from the client device to the resource;
opening a second connection between the mediator and the controller;
receiving, at the mediator, the block of data from the controller, the block of data having previously been received at the controller from the client device; and
transmitting the block of data from the mediator to the resource.

16. The method of claim 12, wherein the request to transfer a block of data is a hypertext transfer protocol (HTTP) POST request.

17. The method of claim 16, further comprising:
receiving, at the mediator, a response to receiving the block of data from the resource; and
transmitting the response to receiving the block of data from the mediator to the controller.

18. The method of claim 17, wherein transmitting the response to receiving the block of data from the mediator to the controller comprises opening a third connection between the mediator and the controller and transmitting the response to receiving the block of data from the mediator to the controller over the third connection.

19. The method of claim 12, wherein the resource comprises a lighting control system configured to control one or more lighting devices.

20. A computer-readable storage medium having instructions stored thereon that, when executed by at least one processor, cause the at least one processor to implement operations comprising:
opening a first bidirectional connection between a mediator and a cloud-based controller, wherein the cloud-based controller is positioned outside of a firewall and configured to communicate with a client device, the firewall being configured to implement security policies to protect a resource from being accessed by unauthorized devices, wherein the mediator is configured to communicate with the cloud-based controller via a communications network, and wherein the mediator is configured to communicate with the resource and is positioned behind the firewall such that communications between the mediator and the resource do not traverse the firewall and communications between the mediator and the cloud-based controller traverse the firewall;
receiving, at the mediator through the first bidirectional connection, a request from the cloud-based controller, the request having been received at the cloud-based controller from the client device;
forwarding the request from the mediator to the resource, the forwarded request being formatted in a manner such that it appears to the resource to be received from the client device;
receiving a response from the resource at the mediator;
opening a second connection between the mediator and the cloud-based controller; and
transmitting the response from the mediator to the cloud-based controller through the second connection, wherein the cloud-based controller is configured to forward the response to the client device.
